(19) United States
(12) Patent Application Publication
(10) Pub. No.: US 2005/0236359 A1
(43) Pub. Date: Oct. 27, 2005

(54) Copper/copper alloy surface bonding promotor and its usage

(76) Inventor: Ginning Hu, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/829,286

(22) Filed: Apr. 22, 2004

(51) Int. Cl. H01B 13/00; B44C 1/22; C23F 1/00

(52) U.S. Cl. 216/34; 216/96; 216/100; 216/35; 252/79.1

(57) ABSTRACT

A halogen ion/hydrogen peroxide-free copper/copper alloy surface bonding promotor includes copper oxidant 0.1˜20 wt %, acidic solution prepared from organic acid, inorganic acid, or their compound 5˜20 wt %, and nonionic compound 0.001˜10 wt %. The use of the halogen ion/hydrogen peroxide-free copper/copper alloy surface bonding promotor enables the copper/copper alloy to have a rough surface that exhibits excellent adhesion to resins and superior solderability.

### BACKGROUND OF THE INVENTION

1. Field of the Invention

The present invention relates to a copper/copper alloy surface bonding promotor and more particularly, to such a copper/copper alloy surface bonding promotor, which enables the copper/copper alloy to have a rough surface that exhibits excellent adhesion to resins and superior solderability. The invention relates also to the usage of such a copper/copper alloy surface bonding promotor.

2. Description of the Related Art

During the fabrication of printed circuit boards, copper/copper alloy surfaces may be polished with grinding wheels, cleaned and washed, etched, chemically roughened to improve adhesion of copper/copper alloy surfaces to corrosion preventive agent and their solderability. When processing printed circuit boards with highly integrated fine line patterns, chemical grinding is commonly used to improve adhesion of copper/copper alloy surfaces to resins and their solderability.

Conventional chemical grinding aids generally contain sulfuric acid and sodium persulfate, sulfuric acid and hydrogen peroxide, or OXONE. However, copper/copper alloy surfaces treated with sodium persulfate may not produce the desired rough surfaces, and may cause solder mask to drop or to produce bubbles, and chemical solution in the next treatment pass in between the metal surface and the resin, causing problems between the metal surface and the resin such as oxidized color difference and instability of microetching. Further, etching with sulfuric acid and hydrogen peroxide system can effectively roughen the surfaces of copper/copper alloy, however it tends to decompose hydrogen peroxide or be contaminated with chloride ions and organic substances to lower the etching speed, resulting in low Ra/Rx value, not in conformity with requirements for IC carriers.

U.S. Pat. No. 5,800,859 teaches the use of an adhesion promotion material in process for copper coating printed circuit boards. However, this process is not practical for use in the manufacture of notebook computers and mobile telephones that use high tensile strength FR-5 as resin substrate for circuit boards because the adhesion promotion material weakens the tensile strength of the substrate. U.S. Pat. No. 5,965,036 discloses a microetching composition for copper or copper alloys comprising an oxidant and a polymer compound which contains polyamine chains or a cationic group or both. The composition can produce surfaces of copper or copper alloy exhibiting excellent adhesion to resins. However, the chloride ions contained in the microetching composition may cause the problems of uneven color distribution and ease of oxidation. Further, chloride ions may corrode the equipment.

Therefore, it is desirable to provide a copper/copper alloy surface bonding promotor that eliminates the aforesaid problems.

### SUMMARY OF THE INVENTION

The present invention has been accomplished under the circumstances in view. It is one object of the present invention to provide a copper/copper alloy surface bonding promotor, which can be adaptable to the surface roughening of multi-layer circuit boards to produce surfaces of copper or copper alloy exhibiting excellent adhesion to resins and to effectively prohibit the production of pink rings. It is another object of the present invention to provide a copper/copper alloy surface bonding promotor, which is practical for the manufacture of printed circuit boards with highly integrated fine line patterns. It is still another object of the present invention to provide a copper/copper alloy surface bonding promotor, which prohibits the production of oxidation on the surfaces of copper/copper alloy, and enables the surfaces of copper or copper alloy to exhibit excellent adhesion to resins and superior solderability. It is still another object of the present invention to provide a copper/copper alloy surface bonding promotor, which is adaptable to prepregs and substrates of high tensile strength.

To achieve these and other objects of the present invention the copper/copper alloy surface bonding promotor comprises copper oxidant 0.1˜20 wt %, acidic solution without halogen ion and hydrogen peroxide 5˜20 wt %, nonionic compound having amino/CONH chains 0.001˜10 wt %, and deionized water to make total 100%. The usage of copper/copper alloy surface bonding promotor comprises the steps of: a) providing a circuit board having a copper/copper alloy surface, b) microetching said copper/copper alloy surface with an etchant containing chloride ions/ferrite ions, and c) roughening the etched copper/copper alloy surface with a surface bonding promotor, which comprises copper oxidant 0.1˜20 wt %, acidic solution without halogen ion and hydrogen peroxide 5˜20 wt %, and nonionic compound having amino/CONH chains 0.001˜10 wt %.

### BRIEF DESCRIPTION OF THE DRAWINGS

FIG. 1 is an electronic microscope picture obtained from copper foils treated with a surface bonding promotor prepared according to example I of the present invention.

FIG. 2 is an electronic microscope picture obtained from copper foils treated with a surface bonding promotor prepared according to example II of the present invention.

FIG. 3 is an electronic microscope picture obtained from copper foils treated with a surface bonding promotor prepared according to example III of the present invention.

FIG. 4 is an electronic microscope picture obtained from copper foils treated with a surface bonding promotor prepared according to example IV of the present invention.

FIG. 5 is an electronic microscope picture obtained from copper foils treated with a surface bonding promotor prepared according to comparison example I.

FIG. 6 is an electronic microscope picture obtained from copper foils prepared according to comparison example II.

### DETAILED DESCRIPTION OF THE PREFERRED EMBODIMENT

A copper/copper alloy surface bonding promotor in accordance with the present invention is comprised of 0.1˜20 wt % copper oxidant, 5˜20 wt % organic acid without halogen ions and hydrogen peroxide, inorganic acid, or acidic mixture of organic acid and inorganic acid, and a compound containing 0.001˜10 wt % nonionic or amphoteric surfactant.

The oxidant can be OXONE, sodium persulfate, potassium persulfate, copper oxide, copper carbonate, or their mixture. Preferably, the content of oxidant is 0.1˜10 wt %. Oxidant content less than 1 wt % may result in micro-etching incapability. Excessively high amount of oxidant content may result in smooth copper surface.

Nonionic polymer compound is soluble in water. It can be commercially available Diethanolamidde, Poly ethylene diamine, Soromine, Tralkyl amine oxide, COCONUT Diethanolamide, Lanri Diethanolamine, COCONUT Monoethanolamide, Lauryl Dimethyl Amine Oxide, Tallow Amine Ethoxylate, Cocoamidopropyl Dimethyl Betaine, Lauramidopropyl Dimethyl Betaine, Lauryl Dimethyl Betain, Tallow Dihydroxy Betaine, Imidazolinium Betaine, or their mixture. Preferably, its content is within 0.001˜5 wt %.

Organic acid can be, for example, citric acid, malic acid, lactic acid, or unsaturated fatty acid such as acrylic acid, butyric acid, methyl amino-sulfoacid, DMAB. Because the invention does not contain halogen ions or hydrogen peroxide, inorganic acid can be sulfuric acid, nitric acid, phosphoric acid, or amino-sulfoacid.

The content of organic acid and inorganic acid is preferably within about 5˜20 wt %. Below this range, copper oxide may be not completely soluble, and a stain may be produced on copper surface.

Further, salt group such as sodium salt, potassium salt, ammonium salt, or organic ammonium such as ethylenediamide, phenylamine, ethanolamine, triethanolamine, etc., may be added to the promotor to increase stability of the solution.

When using the surface bonding promotor of the present invention, microetch the copper and copper alloy surface of the circuit board with halogen ion-contained microetchant such as chloride. Microetching process can be performed by way of spraying or immersion. The optimum operation temperature is blow 20° C.˜40° C. Using the surface bonding promotor of the present invention to roughen the copper surfaces obtain sufficient Ra/Rz when microetching the copper surfaces to the depth of 0.4˜0.5 μm.

The surface bonding promotor of the present invention can be adaptable to the surface roughening of multi-layer circuit boards to produce surfaces of copper or copper alloy exhibiting excellent adhesion to resins and to effectively prohibit the production of pink rings. In comparison to the adhesion promotion material that includes 0.1 to 20% by weight hydrogen peroxide, an inorganic acid, an organic corrosion inhibitor and a surfactant as indicated in U.S. Pat. No. 5,800,859, the copper surfaces treated with the surface bonding promotor of the present invention exhibits superior tensile strength. When used in the manufacture of different printed circuit boards for semiconductor packages such as PGA, BGA, Flip Chip, FC, and etc., the invention exhibits excellent adhesion to the resin of back-glued copper foils.

The surfaces of copper and copper alloy treated with the two-step microetching treatment according to the present invention have excellent metal wetting power, thereby exhibiting superior solderability during further organic antioxidation. Further, an even smooth solder surface can be obtained when treated with solder spraying. The application of the present invention is not limited to the bonding of organic high polymer compound to obtain superior solderability. The invention can also be applied to pre-treatment of metals including chemical tin, chemical nickel, chemical silver, chemical gold, and chemical copper. In these applications, the roughened surfaces exhibit excellent solderability. Therefore, the invention is practical for use in the manufacture of notebook computers and mobile telephones that use high tensile strength FR-5 as circuit board resin substrate. In this application, the degree of peel strength can be proved by way of the tensile strength examination.

Unlike regular chemical etching, the invention achieves the desired surface roughness for excellent solderability simply by means of microetching to the depth of 0.4˜0.5 μm. In comparison to the surface treating agents of sulfuric acid and hydrogen peroxide that need to etch to the depth of 1.5˜2.5 μm, the invention is superior to the surface treating agents of sulfuric acid and hydrogen peroxide in the manufacture of printed wiring boards with highly integrated fine line patterns.

For improving the effect of the copper and copper alloy surface bonding promotor of the present invention, exemplars I-IV of the present invention and comparison examples I and II of the prior art were made and described hereinafter.

Table I was established: dipped copper foils of thickness 1 OZ in microetchant at 25° for 30 seconds for surface roughening pre-treatment and then in surface bonding promotor for 10 seconds, and the processed the treated copper foils with 2116HR and inner boards into multi-layer boards, and then evaluated the peel strength of the obtained multi-layer boards subject to IPC-TM-650 2.4.B.I, and then analyzed the surface roughness (Ra/Rz) by way of electronic microscope (JEOL JSM-6360/Japan and surface analyzer WYKO. The roughness value (Ra/Rz) is the height between the recesses (valley) and the protrusions (peak) of the roughened surfaces.

### EXAMPLE I

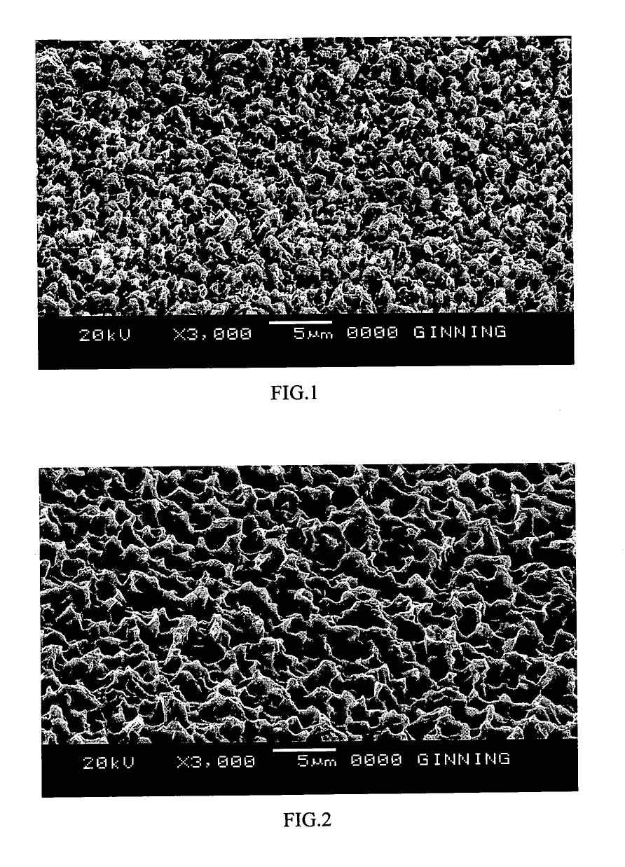

Dipped copper foils of thickness 1 OZ in chloride ion-contained microetchant PC-582 (which was obtained from BEST GINNING ENTERPRISE CO., LTD.) at 25° C. for 30 seconds to roughen the surfaces of the copper foils, and then dipped the etched copper foils in a surface bonding promotor containing sulfuric acid 5 wt %, sodium persulfate 7 wt %, Diethanolamide 5 wt %, and deionized water for 10 seconds to roughen the surfaces of the copper foils, and then the roughened copper foils were viewed under an electronic microscope as shown in FIG. 1, and the surface roughness of the copper foils was measured to be 0.6 Ra/Rz, and then the copper foils were processed with 2116HR and inner boards to make multi-layer boards by heat pressing, and then the tensile strength of the multi-layer boards thus obtained were examined to be 9.8 lb/ln.

### EXAMPLE II

Dipped copper foils of thickness 1 OZ in chloride ion-contained microetchant PC-420 (which was obtained from BEST GINNING ENTERPRISE CO., LTD.) at 25° C. for 30 seconds to roughen the surfaces of the copper foils, and then dipped the etched copper foils in a surface bonding promotor containing methyl amino-sulfoacid 5 wt %, potassium peroxodisulface 5 wt %, Ablumide, Led (surfactant obtained from Taiwan Surfactant Chemical Company) 0.01 wt %, and deionized water for 10 seconds to roughen the surfaces of the copper foils, and then the roughened copper foils were viewed under an electronic microscope as shown in FIG. 2, and the surface roughness of the copper foils was measured to be 0.7 Ra/Rz, and then the copper foils were processed with 2116HR and inner boards to make multi-layer boards by heat pressing, and then the tensile strength of the multi-layer boards thus obtained were examined to be 8.5 lb/ln.

### EXAMPLE III

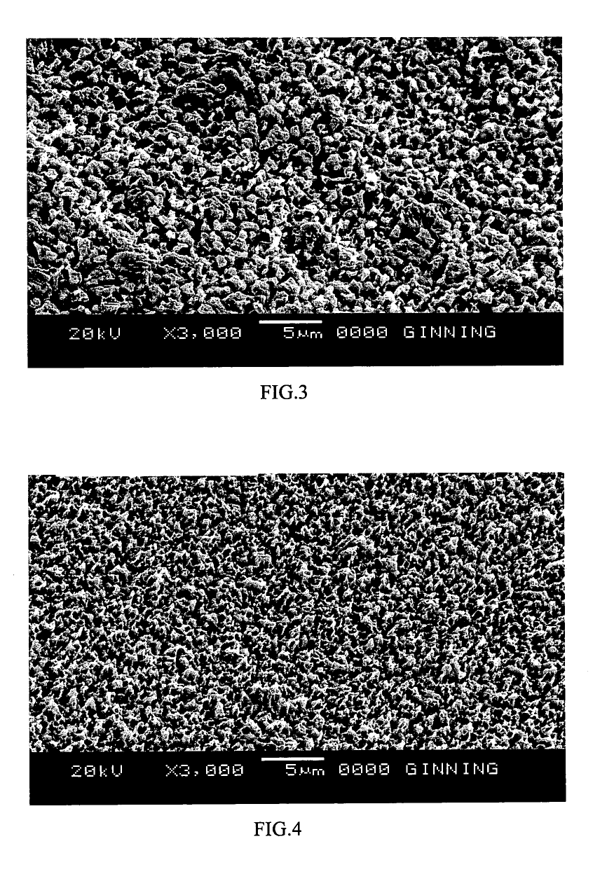

Dipped copper foils of thickness 1 OZ in chloride ion-contained microetchant PC-532 (which was obtained from BEST GINNING ENTERPRISE CO., LTD.) at 25° C. for 30 seconds to roughen the surfaces of the copper foils, and then dipped the etched copper foils in a surface bonding promotor containing sulfuric acid 10 wt %, copper persulfate 20 wt %, SINOBI, LOOST 0.01 wt % and deionized water for 10 seconds to roughen the surfaces of the copper foils, and then the roughened copper foils were viewed under an electronic microscope as shown in FIG. 3, and the surface roughness of the copper foils was measured to be 0.5 Ra/Rz, and then the copper foils were processed with 2116HR and inner boards to make multi-layer boards by heat pressing, and then the tensile strength of the multi-layer boards thus obtained were examined to be 6.0 lb/ln.

### EXAMPLE IV

Dipped copper foils of thickness 1 OZ in chloride ion-contained microetchant PC-420 (which was obtained from BEST GINNING ENTERPRISE CO., LTD.) at 25° C. for 30 seconds to roughen the surfaces of the copper foils, and then dipped the etched copper foils in a surface bonding promotor containing sulfuric acid 5 wt %, copper oxide 5 wt %, ammonium peroxodisulfate 5 wt %, TallowAmideEthoxylate, ABLUMOXt-15 0.1 wt % and deionized water for 10 seconds to roughen the surfaces of the copper foils, and then the roughened copper foils were viewed under an electronic microscope as shown in FIG. 4, and the surface roughness of the copper foils was measured to be 0.8 Ra/Rz, and then the copper foils were processed with 2116HR and inner boards to make multi-layer boards by heat pressing, and then the tensile strength of the multi-layer boards thus obtained were examined to be 12 lb/ln.

### COMPARISON EXAMPLE I

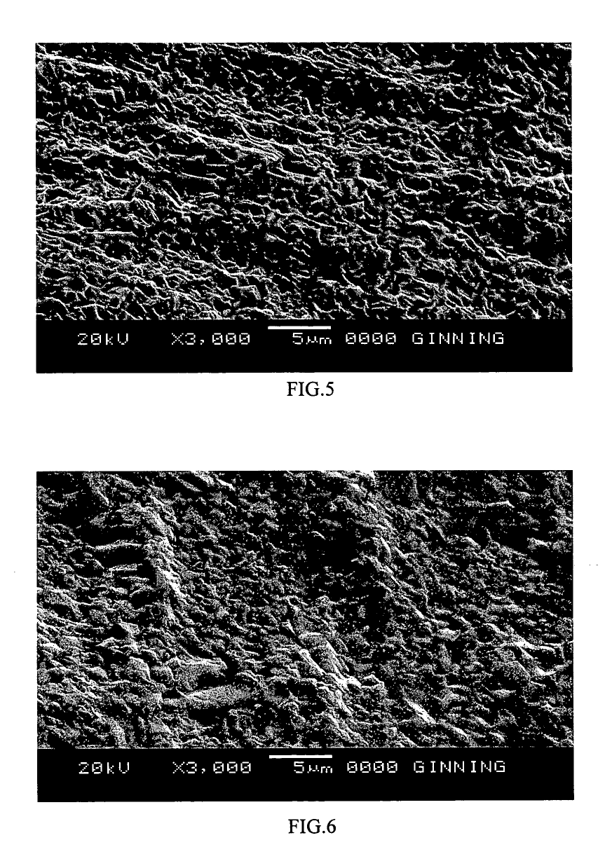

Dipped copper foils of thickness 1 OZ in chloride ion-contained microetchant PC-582 (which was obtained from BEST GINNING ENTERPRISE CO., LTD.) at 25° C. for 30 seconds to roughen the surfaces of the copper foils, and then dipped the etched copper foils in a chemical compound containing sodium persulfate 10 wt %, sulfuric acid 2 wt % and deionized water for 10 seconds to roughen the surfaces of the copper foils, and then the roughened copper foils were viewed under an electronic microscope as shown in FIG. 5, and the surface roughness of the copper foils was measured to be 0.2 Ra/Rz, and then the copper foils were processed with 2116HR and inner boards to make multi-layer boards by heat pressing, and then the tensile strength of the multi-layer boards thus obtained were examined to be 1.0 lb/ln.

### COMPARISON EXAMPLE

Dipped copper foils of thickness 1 OZ in chloride ion-contained microetchant PC-582 (which was obtained from BEST GINNING ENTERPRISE CO., LTD.) at 25° C. for 30 seconds to roughen the surfaces of the copper foils, and then dipped the etched copper foils in a chemical compound containing sulfuric acid 10 wt %, hydrogen peroxide 10 wt % and deionized water for 10 seconds to roughen the surfaces of the copper foils, and then the roughened copper foils were viewed under an electronic microscope as shown in FIG. 6, and the surface roughness of the copper foils was measured to be 0.3 Ra/Rz, and then the copper foils were processed with 2116HR and inner boards to make multi-layer boards by heat pressing, and then the tensile strength of the multi-layer boards thus obtained were examined to be 1.5 lb/ln.

From the microscope pictures shown in FIGS. 1˜6, it is obvious that the surfaces of the copper treated with a surface bonding promotor prepared according to the present invention exhibits excellent surface roughness when examined through a surface analyzer, and high tensile strength when examined through a peel strength test.

Although particular embodiments of the invention have been described in detail for purposes of illustration, various modifications and enhancements may be made without departing from the spirit and scope of the invention.

TABLE I

| | Echant | Surface bonding promotor (wt %) | Ra/Rz | lb/in | SEM |
|---|---|---|---|---|---|
| Exemplar I | 20% PC-582 | Sulfuric acid 5% | 0.6 | 9.8 | |
| | | Sodium persulfate 7% | | | |
| | | Diethanolamide 5% | | | |
| | | Deionized water to make 100% | | | |
| Exemplar II | 20% PC-420 | Methyl amino-sulfoacid 5 wt % | 0.7 | 8.5 | |
| | | Potassium peroxodisulfate 5 wt % | | | |
| | | Ablumide, Led 0.0 1 wt % | | | |
| | | Deionized water to make 100% | | | |
| Exemplar | 20% PC-582 | Sulfuric acid 10% | 0.5 | 6.0 | |
| III | | Copper sulfate 20% | | | |
| | | SINOBI, LOOST 0.01% | | | |
| | | Deionized water to make 100% | | | |
| Exemplar | 20% PC-429 | Sulfuric acid 5% | 0.8 | 12 | |
| IV | | Copper oxide 5% | | | |
| | | Ammonium peroxodisulfate 5 wt % | | | |
| | | TallowAmideEthoxylate, | | | |
| | | ABLUMOXt-15 0.1 wt % | | | |
| | | Deionized water to make 100% | | | |
| Comparison | 20% PC-582 | Sodium persulfate 10% | 0.2 | 1.0 | |
| Example I | | Sulfuric acid 2% | | | |
| | | Deionized water to make 100% | | | |
| Comparison | 20% PC-582 | Sulfuric acid 10% | 0.3 | 1.5 | |
| Example II | | Hydrogen peroxide 10% | | | |
| | | Deionized water to make 100% | | | |

1. A copper/copper alloy surface bonding promotor comprising:
copper oxidant 0.1˜20 wt %;
acidic solution without halogen ion and hydrogen peroxide 5˜20 wt %;
nonionic compound having amino/CONH chains (0.001˜10 wt %; and
deionized water to make total 100%.

2. The copper/copper alloy surface bonding promotor as claimed in claim 1, wherein said acidic solution is selected from organic acid, inorganic acid, and their mixture.

3. The copper/copper alloy surface bonding promotor as claimed in claim 1, wherein said copper oxidant is selected from potassium peroxodisulfate, sodium persulfate, potassium persulfate, copper sulfate, copper oxide, and their mixture.

4. The copper/copper alloy surface bonding promotor as claimed in claim 1, wherein said nonionic compound is a surfactant soluble to water.

5. The copper/copper alloy surface bonding promotor as claimed in claim 2, wherein said organic acid is selected from the acidic group of unsaturated fatty acid and methyl Amidosulfuric Acid.

6. The copper/copper alloy surface bonding promotor as claimed in claim 5, wherein said unsaturated fatty acid is selected from the acidic group of citric acid, malic acid, lactic acid, acrylic acid, and butyric acid.

7. The copper/copper alloy surface bonding promotor as claimed in claim 2, wherein said inorganic acid is selected from the acidic group of sulfuric acid, nitric acid, phosphoric acid, and Amidosulfuric Acid.

8. The usage of copper/copper alloy surface bonding promotor comprising the steps of:
a) providing a circuit board having a copper/copper alloy surface;
b) microetching said copper/copper alloy surface with an etchant containing chloride ions/ferrite ions; and
c) roughening the etched copper/copper alloy surface with a surface bonding promotor, which comprises copper oxidant 0.1˜20 wt %, acidic solution without halogen ion and hydrogen peroxide 5˜20 wt %, and nonionic compound having amino/CONH chains 0.001˜10 wt %.

9. The usage of a copper/copper alloy surface bonding promotor as claimed in claim 8, wherein said microetching is achieved by means of spraying/immersion.

10. The usage of a copper/copper alloy surface bonding promotor as claimed in claim 8, wherein the process of roughening the etched copper/copper alloy surface with a surface bonding promotor is preferably performed at temperature range within 20˜40° C.

11. The usage of a copper/copper alloy surface bonding promotor as claimed in claim 8, wherein said acidic solution is selected from organic acid, inorganic acid, and their mixture.

12. The usage of a copper/copper alloy surface bonding promotor as claimed in claim 8, wherein said copper oxidant is selected from potassium peroxodisulfate, sodium persulfate, potassium persulfate, copper sulfate, copper oxide, copper carbonate, and their mixture.

13. The usage of a copper/copper alloy surface bonding promotor as claimed in claim 8, wherein said nonionic compound is a surfactant soluble to water.

14. The usage of a copper/copper alloy surface bonding promotor as claimed in claim 11, wherein said organic acid is selected from the acidic group of unsaturated fatty acid and methyl Amidosulfuric Acid.

15. The usage of a copper/copper alloy surface bonding promotor as claimed in claim 11, wherein said inorganic acid is selected from the acidic group of sulfuric acid, nitric acid, phosphoric acid, and Amidosulfuric Acid.
